(19) United States
(12) Patent Application Publication
(10) Pub. No.: US 2024/0320448 A1
(43) Pub. Date: Sep. 26, 2024

(54) INFORMATION PROCESSING APPARATUS AND INFORMATION PROCESSING METHOD

(71) Applicant: SONY GROUP CORPORATION, TOKYO (JP)

(72) Inventor: JUNKI OHMURA, TOKYO (JP)

(21) Appl. No.: 18/575,904

(22) PCT Filed: Mar. 9, 2022
(86) PCT No.: PCT/JP2022/010202

§ 371 Date: Jan. 2, 2024

(30) Foreign Application Priority Data
Jul. 14, 2021 (JP) 2021-116296

(51) Int. Cl. G06F 40/53; G06F 16/245; G06F 40/30

(52) U.S. Cl. CPC G06F 40/53; G06F 16/245; G06F 40/30

(57) ABSTRACT

An information processing apparatus (10) includes a conversion unit (11ba) that converts any two notations into a linguistic unified space representation in a case where the two notations are input, the two notations being targets for determining whether or not the two notations are in a notation variation relationship with each other, and a notation variation determination unit (11bb) (corresponding to an example of a “determination unit”) that receives a conversion result by the conversion unit (11ba) as an input and determines the notation variation relationship between the two notations on a basis of a feature amount related to a notation variation included in the conversion result.

### FIELD

The present disclosure relates to an information processing apparatus and an information processing method.

### BACKGROUND

Conventionally, in character notation indicating one entity, what is called “notation variation” is known in which a notation varies due to being written in two or more ways.

The notation indicating one entity varies depending on the character type handled by each country. Among them, Japanese is known as a language that is tolerant of notation, and various notation variations are likely to occur. For this reason, even if a user such as an application developer who wants to acquire and utilize notation data indicating a certain entity acquires a notation considered to correspond from a wide variety of notations via the Internet or the like, it is not easy to accurately determine whether the notation is a necessary notation.

Therefore, as a countermeasure, for example, it is conceivable to organize notation variations with a dictionary. As a technique for this purpose, for example, a technique has been proposed in which a search is performed with an appropriate term considered to be a notation variation possibility from a document group, and an editing distance obtained by adjusting a cost with respect to a retrieved term is measured to collect a term determined to be a notation variation from among retrieved terms (see, for example, Patent Literature 1).

### CITATION LIST

### Patent Literature

Patent Literature 1: JP 2005-352888 A

### SUMMARY

### Technical Problem

However, in the above-described conventional technique, there is room for further improvement in easily determining notation variation and structuring notation data without considering differences in a character type or a linguistic zone of the notation.

Accordingly, the present disclosure proposes an information processing apparatus and an information processing method capable of easily determining notation variation and structuring notation data without considering differences in a character type or a linguistic zone of the notation.

### Solution to Problem

In order to solve the above problems, one aspect of an information processing apparatus according to the present disclosure includes a conversion unit that converts any two notations into a linguistic unified space representation in a case where the two notations are input, the two notations being targets for determining whether or not the two notations are in a notation variation relationship with each other, and a determination unit that receives a conversion result by the conversion unit as an input and determines the notation variation relationship between the two notations on a basis of a feature amount related to a notation variation included in the conversion result.

### BRIEF DESCRIPTION OF DRAWINGS

FIG. 1 is an explanatory diagram (part 1) regarding definitions of terms according to an embodiment of the present disclosure.

FIG. 2 is an explanatory diagram (part 2) regarding definitions of terms according to the embodiment of the present disclosure.

FIG. 3 is an explanatory diagram (part 3) regarding definitions of terms according to the embodiment of the present disclosure.

FIG. 4 is a schematic explanatory diagram of an information processing method according to the embodiment of the present disclosure.

FIG. 5 is a block diagram illustrating a configuration example of an information processing apparatus according to the embodiment of the present disclosure.

FIG. 6 is a schematic explanatory diagram of a notation variation determination model.

FIG. 7 is a block diagram illustrating a configuration example of the notation variation determination model.

FIG. 8 is a diagram illustrating feature amounts used by a notation variation determination unit.

FIG. 9 is an explanatory diagram (part 1) regarding notation variations of subwords.

FIG. 10 is an explanatory diagram (part 2) regarding notation variations of subwords.

FIG. 11 is an explanatory diagram (part 3) regarding notation variations of subwords.

FIG. 12 is an explanatory diagram (part 4) regarding notation variations of subwords.

FIG. 13 is an explanatory diagram of grouping of notations.

FIG. 14 is a diagram illustrating an example of a GUI screen in a case where two entities exist for the same notation.

FIG. 15 is a diagram illustrating an example of a UI that allows increasing or decreasing such a threshold value in any manner.

FIG. 16 is a diagram illustrating an example of explicitly extracting and displaying a specific notation.

FIG. 17 is a diagram (part 1) illustrating an example of editing processing.

FIG. 18 is a diagram (part 2) illustrating an example of editing processing.

FIG. 19 is a diagram (part 3) illustrating an example of editing processing.

FIG. 20 is a diagram (part 4) illustrating an example of editing processing.

FIG. 21 is a diagram (part 5) illustrating an example of editing processing.

FIG. 22 is a flowchart illustrating a processing procedure executed by the information processing apparatus.

FIG. 23 is a hardware configuration diagram illustrating an example of a computer that implements functions of the information processing apparatus.

### DESCRIPTION OF EMBODIMENTS

Hereinafter, embodiments of the present disclosure will be described in detail with reference to the drawings. Note that in each of the following embodiments, the same parts are denoted by the same reference numerals, and redundant description will be omitted.

Furthermore, the present disclosure will be described according to the following order of items.
1. Summary of embodiment of present disclosure
2. Configuration of information processing apparatus
2-1. Structuring processing
2-1-1. Determination of notation variation
2-1-2. Notation variation of subword
2-1-3. Grouping of notations
2-1-4. Separation of entities and use of context
2-1-5. Change in tolerance of notation variation
2-2. Editing processing
2-3. Processing procedure
3. Modification Example
3-1. Usage of notation database
3-2. Differences from search engine service
3-3. About typo and secret word extraction
3-4. Automatic input of notation list
3-5. Configuration of information processing apparatus
4. Hardware Configuration
5. Conclusion

### 1. Summary of Embodiment of Present Disclosure

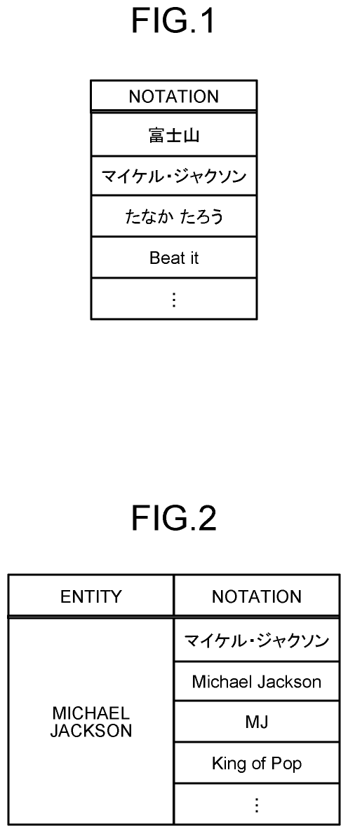

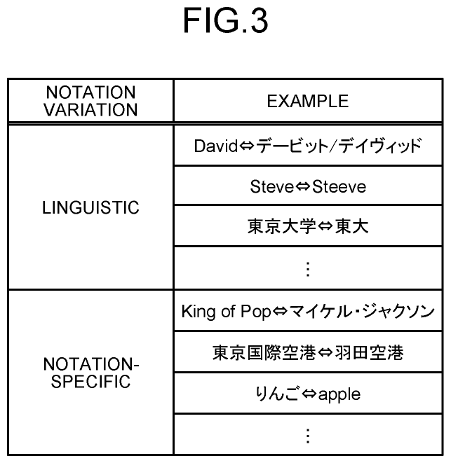

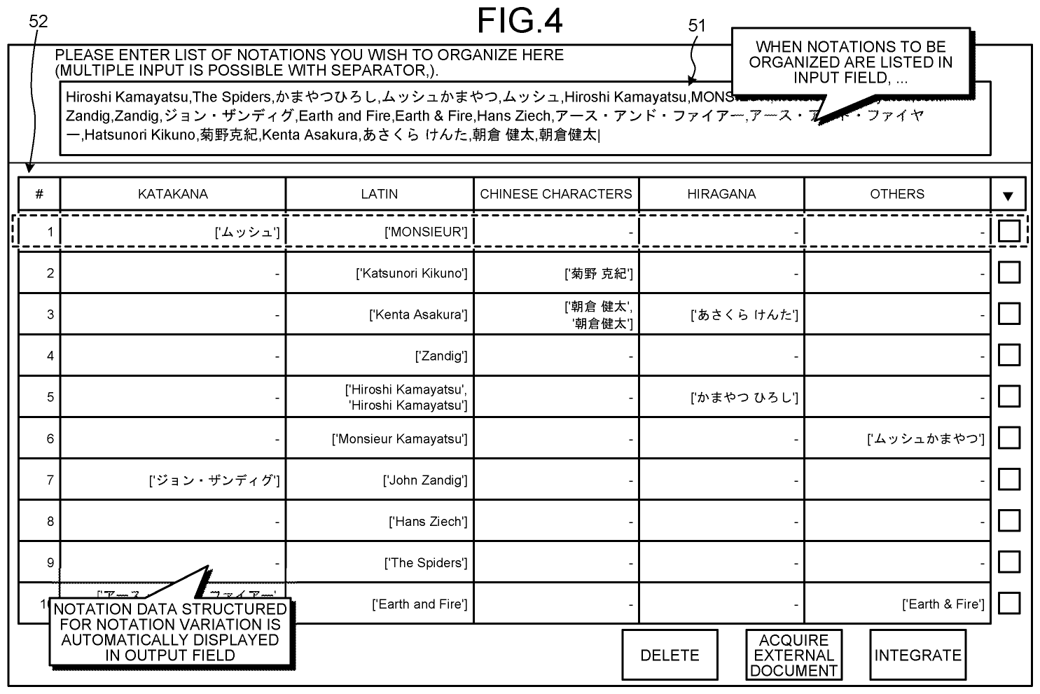

First, an outline of an information processing method according to an embodiment of the present disclosure will be described. FIG. 1 is an explanatory diagram (part 1) regarding definitions of terms according to an embodiment of the present disclosure. Further, FIG. 2 is an explanatory diagram (part 2) regarding the definition of terms according to the embodiment of the present disclosure. Furthermore, FIG. 3 is an explanatory diagram (part 3) regarding the definition of terms according to the embodiment of the present disclosure. Further, FIG. 4 is a schematic explanatory diagram of the information processing method according to the embodiment of the present disclosure.

A description will be given from definitions of terms according to the embodiment of the present disclosure. In the embodiment of the present disclosure, a “notation” refers to a list of characters, in other words, a string of characters. As illustrated in FIG. 1, the “notation” includes various character types such as Chinese characters, katakana, hiragana, alphabets, and symbols. In the example of FIG. 1, for example, the “notation” is [symbol] , [symbol] , [symbol] , “Beat it”, and the like.

Furthermore, in the embodiment of the present disclosure, “entity” refers to one matter or one thing as a concept. As illustrated in FIG. 2, for example, notations such as [symbol] , “Michael Jackson”, “MJ”, and “King of Pop” refer to the “entity” of the singer “Michael Jackson”.

In addition, in the embodiment of the present disclosure, “notation variation” refers to different notations that refer to the same entity. For example, notations such as [symbol] , “Michael Jackson”, “MJ”, and “King of Pop” illustrated in FIG. 2 are in a relationship of notation variation with each other.

Note that, as illustrated in FIG. 3, “notation variation” can be roughly divided into two types of notation variations: “linguistic” notation variation or “notation-specific” notation variation. The embodiment of the present disclosure is mainly directed to the “linguistic” notation variation. The “linguistic” notation variation is a notation variation phenomenon that occurs in common in specific notations such as general katakana regardless of notation-specific (for example, semantic) information, and as illustrated in FIG. 3, for example, variation due to a similar pronunciation, typo, abbreviation, or the like.

On the other hand, the “notation-specific” variation is a notation variation event that occurs due to information of the notation itself, and as illustrated in FIG. 3, for example, variation by a nickname, another name, translation, or the like.

Meanwhile, the existing technique related to notation variation has room for further improvement in easily determining notation variation and structuring notation data without considering differences in a character type or a linguistic zone of the notation.

For example, there is an existing technique in which a search is performed with an appropriate term considered to be a notation variation possibility from a document group, and an editing distance obtained by adjusting a cost with respect to a retrieved term is measured to collect a term determined to be a notation variation from among retrieved terms.

However, in such an existing technique, since the determination of the notation variation is performed on the basis of the editing distance of the notation itself, notation between different character types cannot be handled. Further, due to this, it is not possible to classify by character type.

In addition, although it is simple as a method to organize notation variations in a dictionary, there is a problem that the scale merit is small and the cost such as manpower and time becomes high.

Note that a company that develops and provides a large-scale search engine service such as Google (registered trademark) or Bing (registered trademark) is considered to be able to handle notation variation between different character types by collecting a large amount of correspondence data between a search query and a web page, for example. However, it is difficult for other companies and general users to obtain such data, and it can be said that the data lacks versatility.

Furthermore, with respect to a personal name or a place name, a new word occurs almost infinitely for its notation. For this reason, even if collected data of a search engine can be used for such an unknown word or a rare term indicating a personal name or a place name, it can be said that structuring of notation variation is not easy.

Therefore, in the information processing method according to the embodiment of the present disclosure, in a case where any two notations to be determined as to whether or not the two notations are in the notation variation relationship with each other are input, the two notations are converted into the linguistic unified space representation, a conversion result by the conversion is used as an input, and the notation variation relationship between the two notations is determined on the basis of the feature amount regarding the notation variation included in the conversion result.

Specifically, in the information processing method according to the embodiment of the present disclosure, a graphical user interface (GUI) screen as illustrated in FIG. 4 is provided to the user. As illustrated in FIG. 4, such a GUI screen includes an input field 51 and an output field 52.

The input field 51 receives, from the user, an input of a list of notations (hereinafter appropriately referred to as a “notation list”) that the user wants to organize regarding notation variation. The notation list may be a list of notations related to a single entity or a list of notations related to a plurality of entities.

Then, in the information processing method according to the embodiment of the present disclosure, when the user lists notations that the user wants to organize in the input field 51, notation data structured for notation variation is automatically displayed in the output field 52.

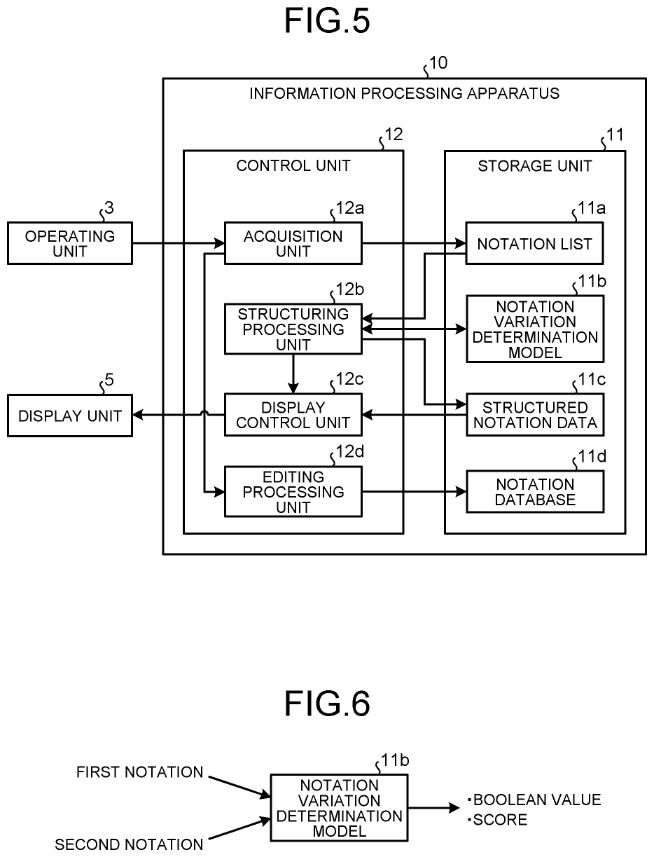

When the structured notation data with respect to the notation list in the input field 51 is displayed in the output field 52, structuring processing using a notation variation determination model 11b (see FIG. 5 and the like) is performed.

In this structuring processing, in the information processing method according to the embodiment of the present disclosure, first, the input notation list is normalized. The normalization mentioned here is, for example, unification of lower case and upper case letters, unification of half-width and full-width letters, and the like.

Subsequently, in the structuring process, pairs of two notations (hereinafter, referred to as “indicated pair” as appropriate) are sequentially created from the notation list, and grouping is performed based on the relationship of notation variation (hereinafter appropriately referred to as a “notation variation relationship”) in such notation pairs.

Then, in the structuring processing, notations in each of grouped groups are classified by notation type. FIG. 4 illustrates an example in which each row indicated by a dashed rectangle corresponds to one group, and the notation is classified for each character type as the notation type. Note that details of the structuring process will be described later with reference to FIG. 5 and subsequent drawings.

The user can grasp the notation variation relationship of each notation of the notation list arbitrarily input by the user at a glance only by confirming the content of each row displayed in the output field 52 in this manner.

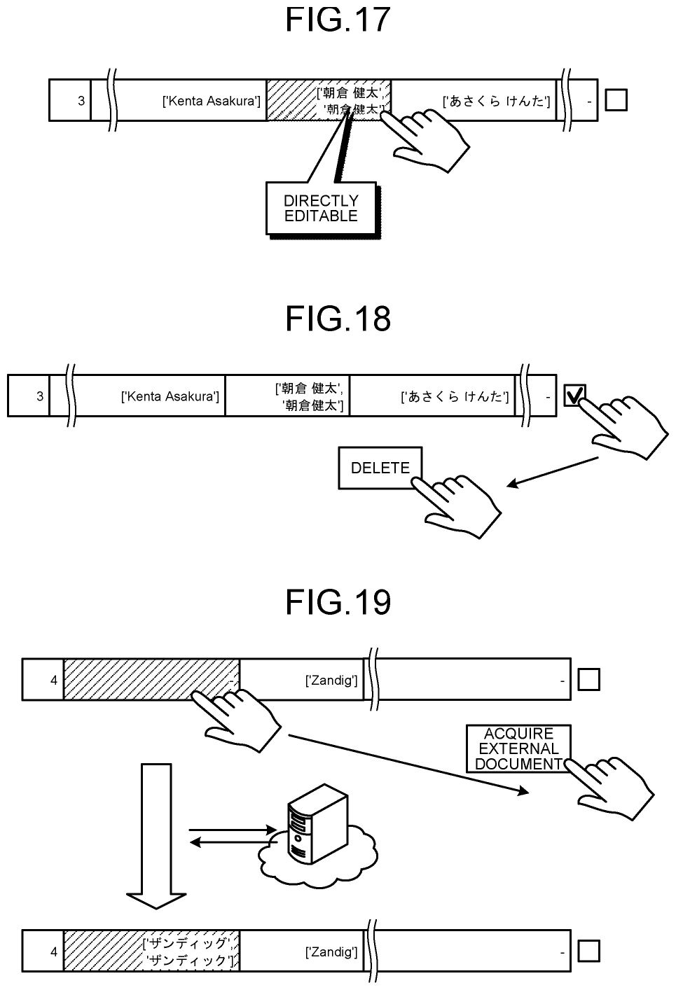

In addition, the notation data structured in this manner can be manually or automatically edited as appropriate such as corrected or deleted. Details of the editing processing will be described later with reference to FIG. 17 and subsequent drawings.

Further, the structured or appropriately corrected notation data may be reflected in a notation database 11d (see FIG. 5) or output in an appropriate format.

Such a mechanism can be implemented to operate as a software library. Therefore, for example, the program can be incorporated into appropriate software as a portable library, or can be used as a Web API provided by a cloud server. In this case, for example, a notation list and any uniform resource locator (URL) can be input, and structured notation data can be received as an output.

As described above, in the information processing method according to the embodiment of the present disclosure, in a case where any two notations to be determined as to whether or not the two notations are in the notation variation relationship are input, the two notations are converted into the linguistic unified space representation, the conversion result is used as an input, and the notation variation relationship between the two notations is determined on the basis of the feature amount regarding the notation variation included in the conversion result.

Therefore, by the information processing method according to the embodiment of the present disclosure, it is possible to easily determine notation variation and structure notation data without considering differences in a character type or a linguistic zone of the notation.

Hereinafter, a configuration example of an information processing apparatus 10 to which the information processing method according to the embodiment of the present disclosure described above is applied will be described more specifically.

### 2. Configuration of Information Processing Apparatus

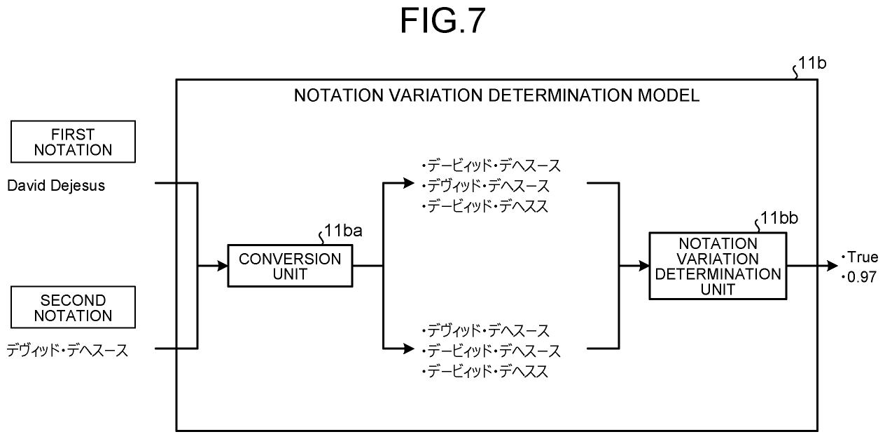

FIG. 5 is a diagram illustrating a configuration example of the information processing apparatus 10 according to the embodiment of the present disclosure. Further, FIG. 6 is a schematic explanatory diagram of the notation variation determination model 11b. Furthermore, FIG. 7 is a block diagram illustrating a configuration example of the notation variation determination model 11b.

Note that FIGS. 5 to 7 illustrate only components necessary for describing features of the embodiment of the present disclosure, and do not illustrate general components.

In other words, each component illustrated in FIGS. 5 to 7 is functionally conceptual, and is not necessarily physically configured as illustrated in the drawings. For example, a specific form of distribution and integration of each block is not limited to the illustrated form, and all or a part thereof can be functionally or physically distributed and integrated in any unit according to various loads, usage conditions, and the like.

Further, in the description using FIGS. 5 to 7, the description of the already described components may be simplified or omitted.

The information processing apparatus 10 is a computer used by a user who wants to acquire notation data structured about notation variation. The information processing apparatus 10 is implemented by, for example, a personal computer (PC) such as a desktop type or a laptop type, a portable terminal such as a smartphone, a tablet terminal, a personal digital assistant (PDA), a server, a workstation, or the like.

As illustrated in FIG. 5, the information processing apparatus 10 includes a storage unit 11 and a control unit 12. Further, in the information processing apparatus 10, an operating unit 3 and a display unit 5 are connected in a wired or wireless manner.

The operating unit 3 is an operation device that receives an operation from a user. The operating unit 3 is implemented by, for example, a mouse, a keyboard, or the like. The display unit 5 is a display device that displays the above-described GUI screen described with reference to FIG. 4 to the user. The display unit 5 is implemented by a display or the like. Note that the operating unit 3 and the display unit 5 may be integrally provided by a touch panel display or the like.

The storage unit 11 is implemented by, for example, a semiconductor memory element such as a random access memory (RAM), a read only memory (ROM), or a flash memory, or a storage device such as a hard disk or an optical disk.

In the example illustrated in FIG. 5, the storage unit 11 stores a notation list 11a, the notation variation determination model 11b, structured notation data 11c, and a notation database 11d. The notation list 11a is a notation list input to the above-described input field 51.

The notation variation determination model 11b is used in a structuring process executed by a structuring processing unit 12b described later. In the structuring process, the notation variation determination process of determining the notation variation relationship for each notation pair described above is recursively repeated. The notation variation determination model 11b is a model for determining the notation variation relationship for each of such notation pairs.

Specifically, as illustrated in FIG. 6, in a case of receiving inputs of two notations of the first notation and the second notation, the notation variation determination model 11b functions as what is called a function that outputs one or both of a Boolean value and a score indicating whether the two notations are in the notation variation relationship.

The structured notation data 11c is notation data structured by the structuring processing unit 12b. The notation database 11d is a database that stores structured notation data or notation data appropriately corrected by the user.

The control unit 12 is a controller, and is implemented by, for example, a central processing unit (CPU), a micro processing unit (MPU), or the like executing various programs (not illustrated) stored in the storage unit 11 using a RAM as a work area. Further, the control unit 12 can be implemented by, for example, an integrated circuit such as an application specific integrated circuit (ASIC) or a field programmable gate array (FPGA).

The control unit 12 includes an acquisition unit 12a, a structuring processing unit 12b, a display control unit 12c, and an editing processing unit 12d, and implements or executes a function and an action of information processing described below.

The acquisition unit 12a acquires content input by the user via the operating unit 3. When the user performs an input operation of a notation list on the input field 51, the acquisition unit 12a acquires the input notation list and stores the acquired notation list as the notation list 11a.

Further, in a case where the user performs an editing operation on the structured notation data, the acquisition unit 12a acquires the input editing content and notifies the editing processing unit 12d of the editing content.

### <2-1. Structuring Processing>

### <2-1-1. Determination of Notation Variation>

The structuring processing unit 12b executes a structuring process of structuring with respect to the notation variation on the notation list 11a. Specifically, in the structuring process, the structuring processing unit 12b first normalizes the notation list 11a.

Further, in a case where the notation is a personal name, the structuring processing unit 12b can divide the notation into a plurality of tokens. For example, if the notation is [symbol] , the token is three tokens of [symbol] , [symbol] , and [symbol] . Furthermore, for example, if the notation is [symbol] , the two tokens of [symbol] and [symbol] are obtained.

Note that, since the order of the first and last names may vary depending on the character type (for example, “Tarou Tanaka” and [symbol] ) due to differences in culture and the like, it is necessary to determine the notation variation by changing the order of the tokens.

Therefore, the structuring processing unit 12b divides each of the first notation and the second notation into tokens, rearranges the order of one notation, and determines the notation variation using the notation variation determination model 11b for each of other notation and token.

At that time, if it is determined that there is a notation variation relationship in all the tokens, a notation variation in the order of the tokens can be seen, and thus a score is returned. In addition, if it is determined that there is no notation variation relationship in all the orders of the tokens, it is determined that there is no notation variation relationship in the first notation and the second notation. When it is determined that there is no notation variation relationship in all the orders of the tokens, the average value of notation variation scores in all the orders of the tokens may be returned as a score. Note that any means can be used to divide the tokens. For example, a divided portion may be partitioned by a symbol (., -, =, space, or the like), or in a case of Chinese character notation of a Japanese name, a first and last name dictionary, a machine learning model for dividing a token learned from the first and last name dictionary, or the like may be used.

As illustrated in FIG. 7, the notation variation determination model 11b includes a conversion unit 11ba and a notation variation determination unit 11bb. The conversion unit 11ba converts the first notation and the second notation into linguistic unified space representation. At this time, the conversion unit 11ba uses, for example, a sequence conversion model or the like learned in advance.

In the example of FIG. 7, the conversion unit 11ba unifies the notations in a katakana space. Note that conversion into a unified space representation by another character type instead of the katakana space may be performed, or conversion into an embedded space (latent space) expression by deep learning may be performed.

Further, the first notation and the second notation are each extended to N-best. For example, when the conversion unit 11ba converts Latin into katakana, the top N (3 in the example of FIG. 7) appropriate conversion results are used.

Note that, even in a case where the input is already katakana, the input can be extended to N-best through reverse conversion such as katakana-Latin-katakana. Since various notation variations may occur in the notation, reliability of the notation variation determination can be enhanced by considering not only one notation but also a further notation variation with respect to the input notation.

Note that, since the N-best of the first notation and the N-best of the second notation are compared with each other, comparison of N×N is necessary, but if a sufficiently high score is observed in the middle, the calculation may be terminated, or an average obtained by weighting the N-best rank may be calculated after calculating all of N×N.

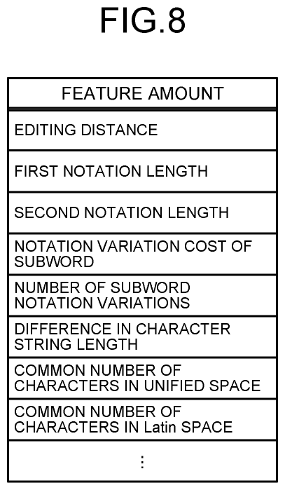

The notation variation determination unit 11bb receives the list of the unified space representations of the first notation and the second notation as an input, and calculates the probability of the notation variation determination. The notation variation determination unit 11bb uses, for example, the feature amount illustrated in FIG. 8. FIG. 8 is a diagram illustrating feature amounts used by the notation variation determination unit 11bb.

As illustrated in FIG. 8, examples of the feature amount include “editing distance”, “first notation length”, “second notation length”, “notation variation cost of subword”, “number of subword notation variations”, “difference in character string length”, “common number of characters in unified space”, “common number of characters in Latin space”, and the like.

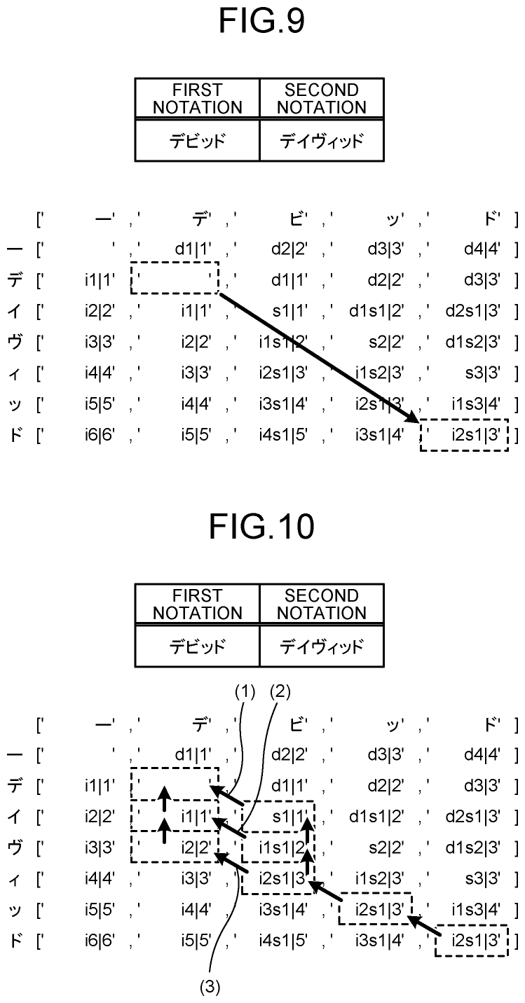

Note that the “subword notation variation” refers to taking statistics of diff of the first notation and the second notation and using the statistics as the feature amount when the notation variation data exists in advance. Such a point will be described later with reference to FIGS. 9 to 12.

Further, for example, in a case of comparison between [symbol] and [symbol] , the “common number of characters in unified space” is “2” because two characters of [symbol] and [symbol] are common. Further, the “common number of characters in Latin space” is, for example, the number of characters common in a case where both [symbol] and [symbol] are represented by the first character in the Roman notation, and is a comparison between “T-MS” and “MIK-”, so that “-” and “M” are common, and is “2”.

In addition to these, a character (alphabet, katakana) or a character position may be treated as the feature amount. Using these feature amounts, the notation variation determination unit 11bb performs binary determination using a method such as a rule base, a decision tree base, or a deep learning base. If there is a score, the score may be output. In a case where the binary determination is performed, a threshold value is necessary, but the threshold value may be adjusted in accordance with a false positive by drawing a receiver operating characteristic (ROC) curve. Alternatively, the threshold value is not determined, and the user may independently set a threshold value.

### <2-1-2. Notation Variation of Subword>

Next, notation variation of subwords will be described. FIGS. 9 to 12 are explanatory diagrams (part 1) to (part 4) relating to notation variation of subwords.

First, in the background in which feature amounts related to the notation variation of subwords are used in the embodiment of the present disclosure, there are many cases (for example, [symbol] that are considered to be natively acceptable in Japanese in the conversion result from Latin to katakana.

Accordingly, in the embodiment of the present disclosure, a notation variation pattern of the katakana of the name of an overseas person is statistically analyzed without depending on the language information, and the analysis using “diff” is performed in order to use for the feature amounts of transliteration and normalization evaluation.

Here, “diff” focuses not only on a simple difference between two notations but also on an editing occurrence position indicating a character position where each of substitution (s), insertion (i), and deletion (d) occurs in a case where one notation is converted into the other notation. By collecting statistics of such “diff” based on the editing distance, it is possible to statistically analyze the notation variation pattern of katakana.

Specifically, the notation variation of subwords can be defined using information obtained in the process of calculating the editing distance from a notation pair having the notation variation relationship. Regarding the editing distance, an alignment relationship between the two notations is checked, insertion, deletion, and replacement costs are calculated, and a cumulative cost to a finally reached cell is employed as the editing distance. More specifically, as illustrated in FIG. 9, in the conversion from [symbol] to [symbol] , the value of the cell in the lower right corner of the editing distance is “i2s1|3”, and thus it can be understood that the editing of the total of “3” of insertion 2 and substitution 1 occurs.

On the other hand, by tracing this in the reverse order, it is possible to calculate an editing path that can be traced in the reverse conversion. Such an editing path is referred to as a diff pattern. More specifically, when following the reverse order of FIG. 9, as illustrated in FIG. 10, it can be understood that there are three diff patterns passing through (1) to (3) in the drawing from the cell at the lower right corner to the cell at which the editing distance is zero.

By collecting this diff pattern through a large number of notational pair cases, statistics of insertion, deletion, and replacement patterns can be calculated. For example, in a case of a deletion (or insertion) operation of one character, it is possible to know the number of times of deletion (or insertion) of the character [symbol] . In addition, in a case of two characters, it is possible to know how much conversion of, for example, [symbol] [symbol] occurs by viewing surrounding words of the editing occurrence position. By using this method, it is possible to automatically acquire a statistic such as a large number of substitutions for [symbol] without using linguistic knowledge.

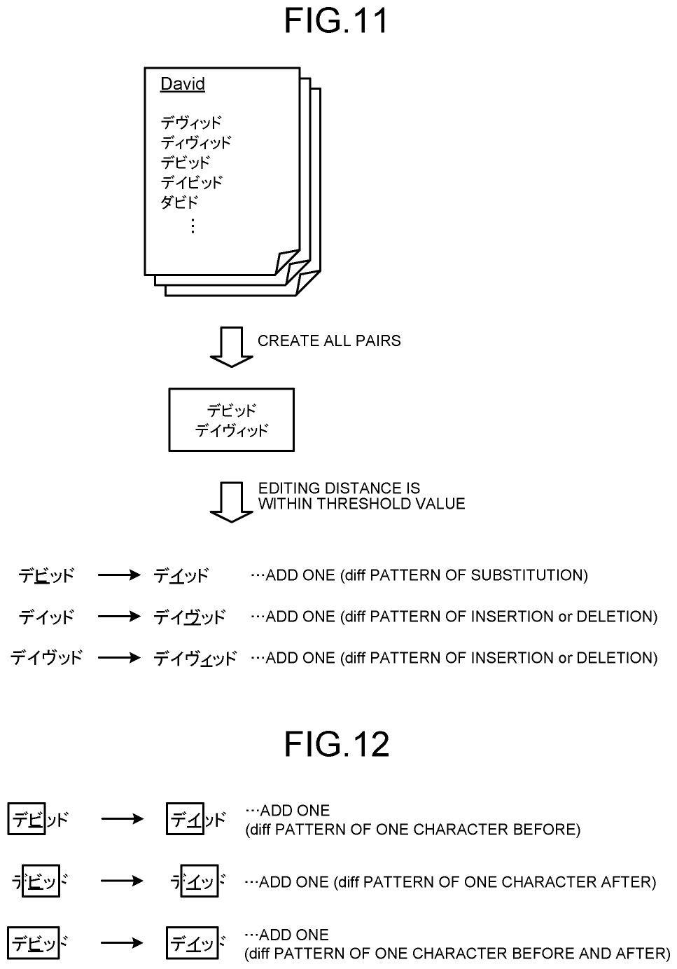

More specifically, as illustrated in FIG. 11, for example, regarding the conversion result of “David” into katakana, all pairs are created, and if the editing distance is within a threshold value for each of the pairs, one is added for each replacement, insertion (or deletion) of the diff pattern.

Further, as illustrated in FIG. 12, without being limited to the editing occurrence portion, one is added for each diff pattern including one character before, one character after, and one character before and after the editing occurrence position.

Note that, although illustration is omitted, in addition to these, one may be added for each combination case of the name corresponding to each of the diff patterns and included in the statistic of the diff pattern. In addition, counting may be performed for each country.

In the notation variation determination model 11b, whether the diff pattern appears in the notation pair to be checked this time is searched using the dictionary of the diff pattern acquired in advance, and when a large number of high-frequency diff patterns occur, the value of the feature amount is set to be large. For such a value, for example, the number of appearances of the diff pattern may be used as it is, or a value such as the number of times (ratio) of the total number of occurrences of replacement of one character may be normalized and then employed as a feature amount.

### <2-1-3. Grouping of Notations>

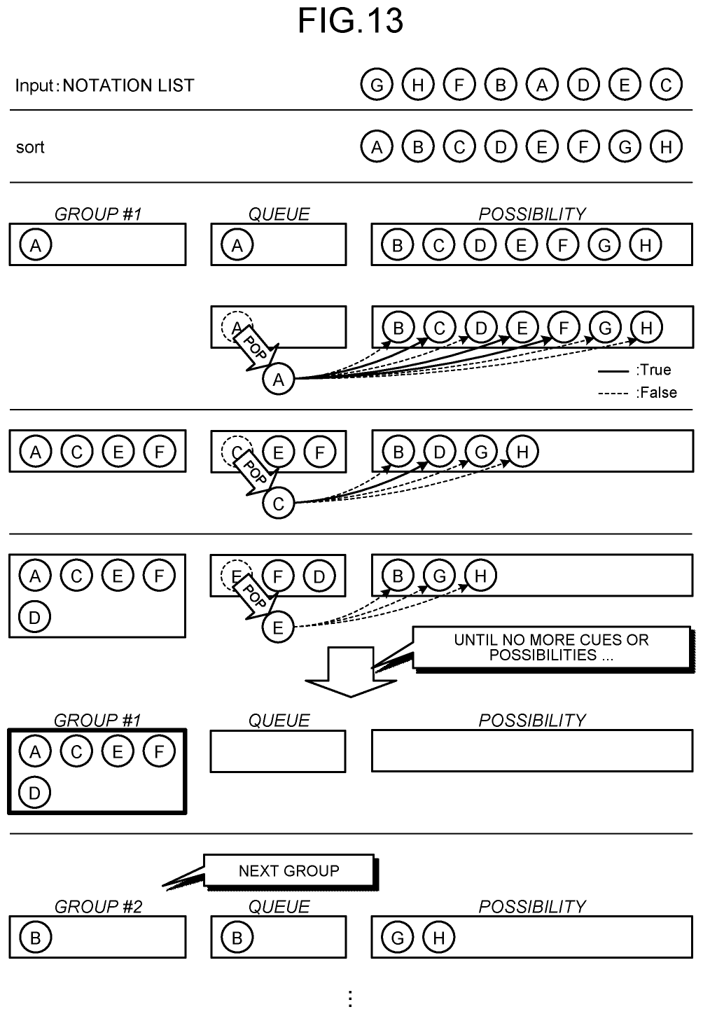

Next, grouping of notations will be described. FIG. 13 is an explanatory diagram of grouping of notations.

Grouping of notations is performed through an algorithm illustrated in FIG. 13. First, the input notation list is sorted. Note that any sorting method may be used as long as the sorting method is consistent in order to maintain consistency of results.

Next, for determination of grouping, the first notation A after sorting is employed as the first group. Then, determination of notation variation of remaining notations B to H is performed. Next, determination of notation variation of notations C to F newly added to the group is similarly performed with respect to the remaining notations B, D, G, and H.

Such a procedure is repeated, and as soon as the queue or the possibility disappears, the group (here, the group #1) is determined, and the remaining head notation B becomes the first notation of the next group. Note that, if the determination of notation variation ideally operates, it is only necessary to confirm the notation that has become the representative notation only for one cycle of determining the notation variation with respect to the remaining notations without performing recursively. However, since the determination of notation variation is not perfect, the coverage of the determination of notation variation is increased by recursively determining the notation variation using gradually different notations.

Note that, after the group is formed, the notation may be further classified by notation type. In FIG. 4 already illustrated, notations are structured separately by character type.

### <2-1-4. Separation of Entities and Use of Context>

Meanwhile, there are cases where different entities have the same notation. For example, in a case where there are a soccer player and an actor with the same family and first name of “Tarou Tanaka”, they are treated as the same notations when only grouping is performed. When it is desired to handle such cases separately, it is conceivable to separate notations by entity.

In a case where notations are exactly the same in a single notation like the same family and first name, there may be a case where determination can be made by using a document in which the notations appear and using surrounding words. In such a case, the entities can be separated by collecting the surrounding words and classifying them into topics, for example.

In addition, in such a case, the topic may be extracted using image recognition, voice recognition, scene recognition, or the like of the medium on the basis of not only the document but also the medium (moving image, voice, or the like) in which the person or the like appears.

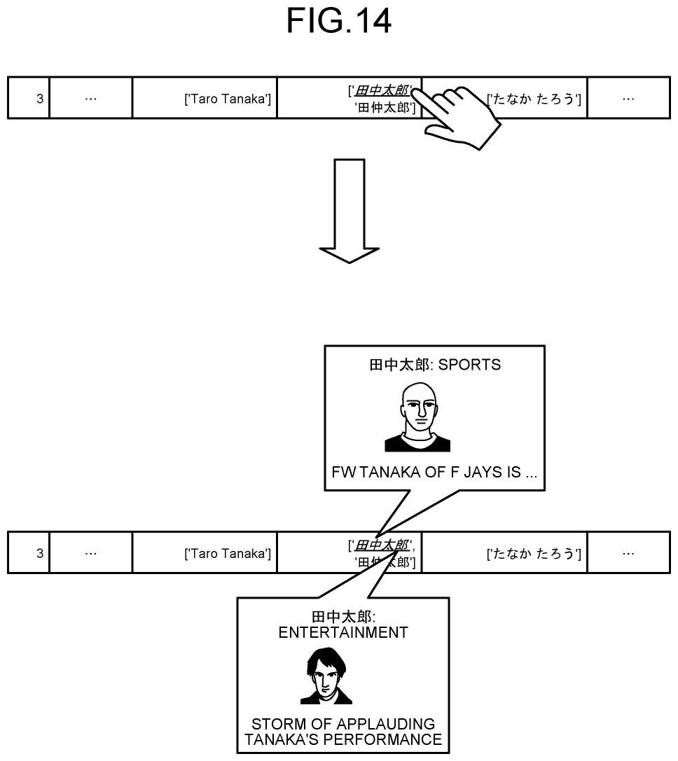

FIG. 14 illustrates an example of a GUI screen in a case where two entities exist for the notation [symbol] . FIG. 14 is a diagram illustrating an example of a GUI screen in a case where two entities exist for the same notation.

As illustrated in FIG. 14, in a case where there are two entities for the notation [symbol] , the display control unit 12c described later causes the notation to be displayed in the output field 52 so as to clearly indicate that the notation [symbol] is selectable in the GUI screen described above.

Then, when the user selects the appropriate notation of [symbol] by, for example, a touch operation or the like, the display control unit 12c searches an appropriate medium and causes display of an appropriate notation and a topic or the like related to each of the two entities corresponding to the notation. Thus, even in a case where different entities are associated with the same notation, the user can confirm each of the entities.

### <2-1-5. Change in Tolerance of Notation Variation>

Meanwhile, as described above, a score of notation variation is obtained at the time of determining the notation variation. Therefore, by increasing or decreasing a threshold value of the score of notation variation, the tolerance of the notation variation can be changed, and the grouping result of the notation list can be changed.

In addition, a threshold value for a specific notation may be increased or decreased instead of the entire notation list. For example, by setting a low threshold value of the notation variation with respect to the representative notation of a certain entity, and a high threshold value with respect to minor notations other than the representative notation, it is possible to find many notations related to the representative notation. Furthermore, this can also be used for full text search and the like.

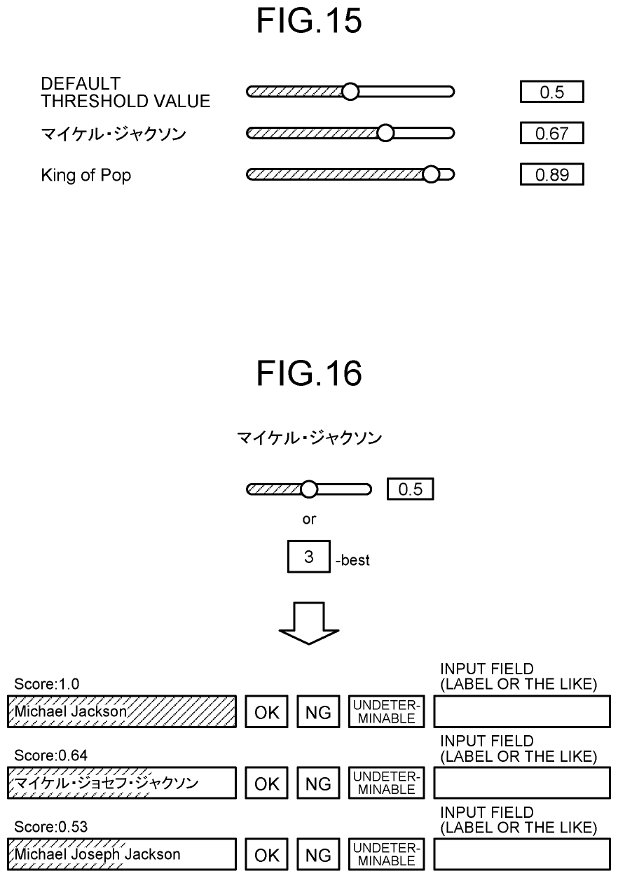

FIG. 15 is a diagram illustrating an example of a UI that allows increasing or decreasing such a threshold value in any manner. FIG. 15 illustrates an example of a UI in which a default threshold value of the entire notation list and a threshold value for specific notations [symbol] and “King of Pop” can be appropriately customized.

In addition, it is also possible to explicitly extract and display a specific notation. FIG. 16 is a diagram illustrating an example in which a specific notation is explicitly extracted and displayed. FIG. 16 illustrates an example in which the notation variation relationship is explicitly displayed in the form of the threshold value designated for the specific notation [symbol] or a score of notation variation by N-best, and the top three notations of such scores.

Furthermore, as illustrated in FIG. 16, in addition to displaying these, UI components may be arranged such that designation of appropriateness (“OK” button), inappropriateness (“NG” button), and undeterminable (“undeterminable” button) of each notation and assignment of a label or the like (“input field”) are enabled.

The description returns to FIG. 5. After executing the structuring process, the structuring processing unit 12b stores the structured notation data as structured notation data 11c.

The display control unit 12c generates a GUI screen to be displayed on the display unit 5 and causes the GUI screen to be displayed on the display unit 5. In addition, the display control unit 12c appropriately generates display contents to be displayed in the output field 52 on the basis of the structured notation data 11c and causes them to be displayed on the display unit 5.

For example, the display control unit 12c causes the display unit 5 to display the GUI screen illustrated in FIG. 4. Furthermore, for example, the display control unit 12c causes the display contents illustrated in FIGS. 14 to 16 to be displayed on the display unit 5.

In addition, the display control unit 12c causes the GUI screen to be displayed so that each line or each notation displayed on the GUI screen can be appropriately edited by the user.

### <2-2. Editing Processing>

The editing processing unit 12d executes editing processing of editing the structured notation data 11c on the basis of edited content of the user acquired via the operating unit 3 by the acquisition unit 12a. Here, an example of the editing processing will be described. FIGS. 17 to 21 are (part 1) to (part 5) illustrating an example of the editing processing.

As illustrated in FIG. 17, for example, when a user's touch operation or a designation operation using a mouse, a keyboard, or the like is applied to each notation displayed in the output field 52 of the GUI screen, the display control unit 12c causes the GUI screen to be displayed so that such a notation can be directly edited. Then, the editing processing unit 12d reflects the edited content in the structured notation data 11c in a case where direct editing is added to such a notation.

That is, the structured notation data may include an error, and in this case, as illustrated in FIG. 17, for example, the user can directly edit and correct the notation data. Note that this function may be used by any user, and may be used, for example, on the technique provider side of the embodiment of the present disclosure, or the client side receiving the provision of the technique.

In addition, the edited content may be stored as new learning data in which an error is a negative example and a correction is a positive example, and may be used by making use of the edited content for application to relearning of the model or for rule base. Note that the relearning at this time may be fine-tuning using a database on the client side, or may be relearning in which cases are returned to the technique provider side and added to the original learning data. Furthermore, since this erroneous case is a good learning case, the notation may be expanded by applying inverse conversion such as katakana→Latin→katakana, and data may be generated (augmentation) as a case that is likely to be erroneous.

In addition, as illustrated in FIG. 18, the display control unit 12c causes, for example, a check box that allows designating each row displayed in the output field 52 in a unit of rows to be displayed on the GUI screen, and causes a “delete” button that enables deletion in the designated unit of rows to be displayed on the GUI screen. Then, when such a check box is designated and the “delete” button is pressed, the editing processing unit 12d reflects the edited content to delete the corresponding row in the structured notation data 11c.

In addition, as illustrated in FIG. 19, for example, when a user's touch operation or a designation operation using a mouse, a keyboard, or the like is applied to a portion where there is no appropriate notation in the output field 52, the display control unit 12c displays a GUI screen so that such a portion is selectable. Further, the display control unit 12c also causes an “acquire external document” button to be displayed on the GUI screen. Then, when such a portion is selected and the “acquire external document” button is pressed, the editing processing unit 12d acquires a notation corresponding to the corresponding position from, for example, a cloud server or the like and reflects the notation in the structured notation data 11c. Then, the display control unit 12c causes the notation reflected in the structured notation data 11c to be displayed on the GUI screen.

That is, FIG. 19 illustrates an example in which the structured notation data is updated by importing an external document instead of manual direct editing. For the external document, notations are extracted in units of personal name notations using a technique such as morphological analysis, and for example, in the example of FIG. 19, it is determined whether or not the external document is in the notation variation relationship with “Zandig” one by one. Alternatively, not limited to one notation, the entire table may be used as a query, and whether there is a notation variation relationship in any of the table may be determined.

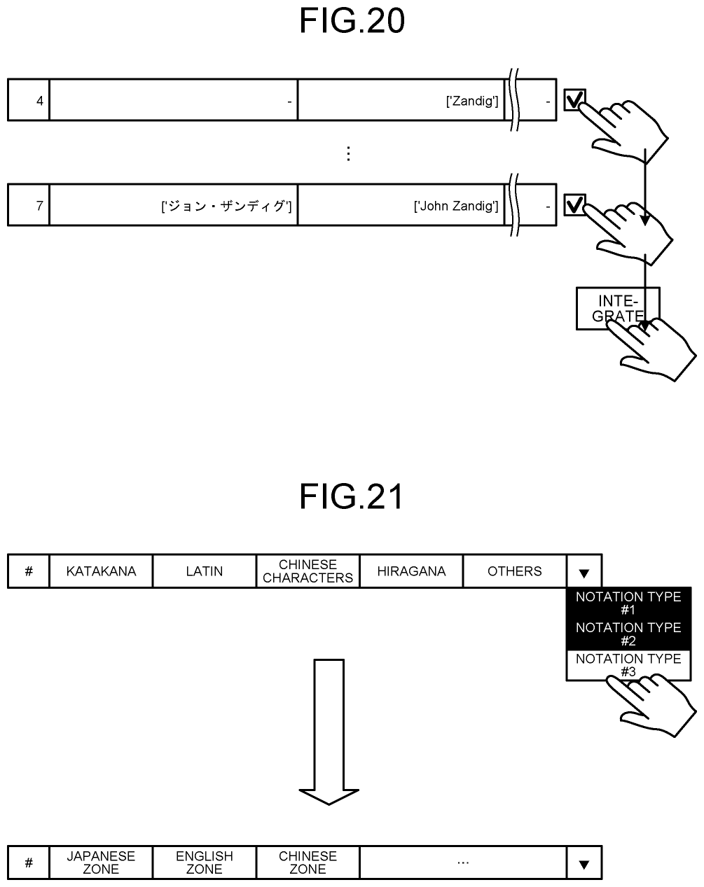

In addition, as illustrated in FIG. 20, the display control unit 12c causes the above-described check box to be displayed so that a plurality of rows displayed in the output field 52 can be designated, for example, and causes an “integrate” button that enables integration of a plurality of designated rows to be displayed on the GUI screen. Then, when a plurality of rows is designated by the check box and the “integrate” button is pressed, the editing processing unit 12d reflects the edited content of integrating the corresponding plurality of rows into one group in the structured notation data 11c.

Note that although FIG. 20 illustrates an example of integration, that is, merging, dividing of one group into a plurality of groups may be allowed. In addition, simultaneous editing or multiple editing by a plurality of users may be allowed.

In addition, as illustrated in FIG. 21, the display control unit 12c causes a GUI screen to be displayed so that, for example, the notation type displayed in the output field 52 can be changed by a drop-down list. Then, when the notation type is changed by the drop-down list, the editing processing unit 12d reflects the change in the structured notation data 11c so that it becomes notation data according to the changed notation type. Then, the display control unit 12c causes the notation data reflected in the structured notation data 11c to be displayed on the GUI screen.

FIG. 21 illustrates an example in which the notation type is changed from the character type to the linguistic zone. The linguistic zone is determined using a character type of notation, a dictionary, or the like. In addition, a character string length, a notation type such as popularity (for example, the number of times a web search or a full text search of a document is performed with a query thereof and a hit is made), and the like are considered. In addition, a program may be uniquely defined on the user side as to what notation type to use. In this case, the notation for each group is given to the program, and the notation type can be classified in an arbitrary program. The pass-through may be performed without doing anything.

### <2-3. Processing Procedure>

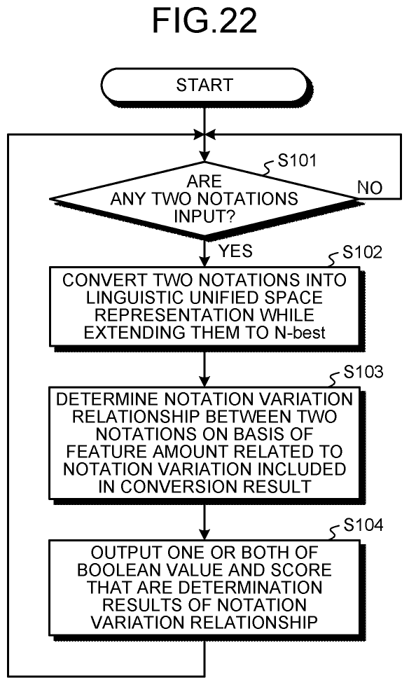

Next, a processing procedure executed by the information processing apparatus 10 will be described with reference to FIG. 22. FIG. 22 is a flowchart illustrating a processing procedure executed by the information processing apparatus 10. Note that, in the description using FIG. 22, the notation variation determination processing using the notation variation determination model 11b included in the structuring processing executed by the structuring processing unit 12b will be mainly described.

As illustrated in FIG. 22, the conversion unit 11ba determines whether or not any two notations to be determined as to whether they are in a notation variation relationship with each other have been input (Step S101). When two notations are input (Step S101, Yes), the conversion unit 11ba converts the two notations into a linguistic unified space (for example, a katakana space) representation while extending the two notations to N-best (Step S102).

Then, the notation variation determination unit 11bb determines the notation variation relationship between the two notations on the basis of the feature amount related to a notation variation included in the conversion result (Step S103).

Then, the notation variation determination unit 11bb outputs one or both of the Boolean value and the score that are determination results of the notation variation relationship (Step S104), and repeats the processing from Step S101.

In addition, in a case where the two notations are not input (Step S101, No), the conversion unit 11ba repeats the processing from Step S101.

### 3. Modification Examples

Note that the above-described embodiment can include some modification examples.

### <3-1. Usage of Notation Database>

The notation database 11d finally generated by the information processing apparatus 10 can be used not only as a dictionary of notation data structured for notation variation but also, for example, as a conversion possibility dictionary for any notation input at the time of input of an Input Method Editor (IME).

In addition, it can also be used for checking other dictionaries generated to include the notation variation relationship.

In addition, in a case where one notation is specified as a search query for a certain search engine, for example, the notation data of the group to which the one notation belongs can be collectively used as a search query dictionary. In such a case, by the user only specifying one notation, even a search by a search query having a notation variation relationship with such a notation is automatically performed, so that the search match rate can be improved.

<3-2. Differences from Search Engine Service>

Note that the search engine service provided by Google (registered trademark), Bing (registered trademark), or the like performs notification for confirming whether the notation is correct, such as “did you mean oo?”, even if a search is performed with a notation including typo or the like, and thus can be said to be a kind of notation variation detection system.

However, this is established only when there is pair data of an enormous search query and actual content of the click destination, and normally, such data cannot be obtained by the user. In addition, since it is a data-driven method, it is not possible to cope with a new word or a private term since there is no data of query content. Furthermore, although it seems that the notation variation is determined at a glance, this can be determined because both queries point to the same content, and the notation variation is merely determined indirectly through the click destination content.

On the other hand, in the embodiment of the present disclosure, it is possible to directly determine the notation variation relationship from the notation pair. Further, in the embodiment of the present disclosure, even if the user does not have linguistic knowledge about the character type and the linguistic zone of each notation to be a target of notation variation determination, the notation variation can be determined, and the notation data can be structured on the basis of the determination.

In addition, as described above, regarding the same notations for different entities, the same notations can be separated by the entities on the basis of content related to each of the entities, and thus it can be said that not only usage for the linguistic notation variation but also usage for the notation unique notation variation is possible.

### <3-3. About Typo and Secret Word Extraction>

Furthermore, as described above, in a case where two notations are input, the conversion unit 11ba converts the two notations into a linguistic unified space representation, and thus, for example, it is possible to extract a typo or a secret word by conversion such as [symbol] .

### <3-4. Automatic Input of Notation List>

Furthermore, in the embodiment of the present disclosure, an example has been described in which the user inputs the notation list to the input field 51 via the operating unit 3, but it is not limited thereto, and the notation list may be automatically input from the outside via, for example, a network, a recording medium, or the like.

### <3-5. Configuration of Information Processing Apparatus>

Furthermore, heretofore, the case where the information processing apparatus 10 is one computer has been described as an example, but the information processing apparatus may be configured as an information processing system including, for example, a server and one or more terminal devices, and the like.

In such a case, the user uses each terminal device to input a notation list via a GUI screen provided from the server, or receives provision of structured notation data. The server performs structuring processing on the basis of the notation list input from each terminal device, and returns the result to each terminal device. Note that, while the GUI screen is shared by a plurality of terminal devices, structured notation data corresponding to one notation list may be generated or edited in cooperation.

Furthermore, among the processes described in the above embodiments, all or part of the processes described as being performed automatically can be performed manually, or all or part of the processes described as being performed manually can be performed automatically by a publicly known method. Further, the processing procedure, specific name, and information including various data and parameters illustrated in the document and the drawings can be arbitrarily changed unless otherwise specified. For example, the various types of information illustrated in each figure are not limited to the illustrated information.

Further, as described above, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in any unit according to various loads, usage conditions, and the like.

In addition, the above-described embodiments can be appropriately combined in a region in which the processing contents do not contradict each other. In addition, the order of each step illustrated in the sequence diagram or the flowchart of the present embodiment can be changed as appropriate.

### 4. Hardware Configuration

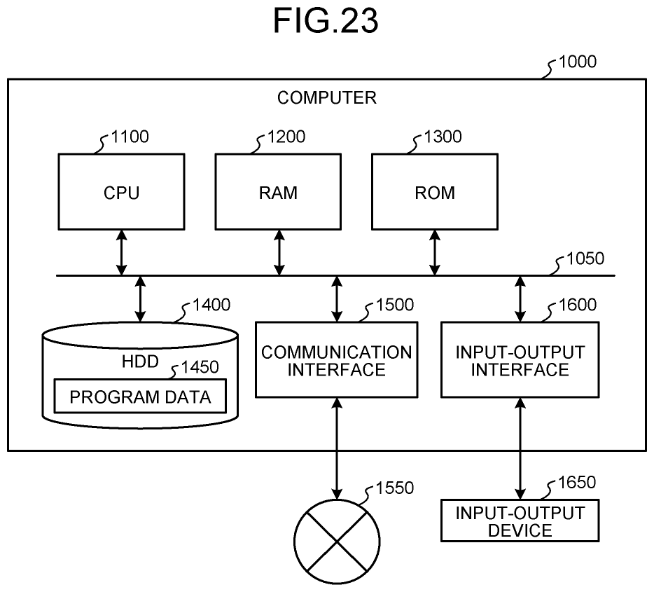

The information processing apparatus 10 according to the above-described embodiment is implemented by, for example, a computer 1000 having a configuration as illustrated in FIG. 23. FIG. 23 is a hardware configuration diagram illustrating an example of the computer 1000 that implements the functions of the information processing apparatus 10. The computer 1000 includes a CPU 1100, a RAM 1200, a ROM 1300, a storage 1400, a communication interface 1500, and an input-output interface 1600. Each unit of the computer 1000 is connected by a bus 1050.

The CPU 1100 operates on the basis of a program stored in the ROM 1300 or the storage 1400, and controls each unit. For example, the CPU 1100 develops a program stored in the ROM 1300 or the storage 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The storage 1400 is a computer-readable recording medium that non-transiently records a program executed by the CPU 1100, data used by such a program, and the like. Specifically, the storage 1400 is a recording medium that records an information processing program according to the present disclosure as an example of program data 1450.

The communication interface 1500 is an interface for the computer 1000 to connect to an external network 1550. For example, the CPU 1100 receives data from another device or transmits data generated by the CPU 1100 to another device via the communication interface 1500.

The input-output interface 1600 is an interface for connecting an input-output device 1650 and the computer 1000. For example, the CPU 1100 can receive data from an input device such as a keyboard and a mouse via the input-output interface 1600. Further, the CPU 1100 can transmit data to an output device such as a display, a speaker, or a printer via the input-output interface 1600. Furthermore, the input-output interface 1600 may function as a media interface that reads a program or the like recorded in a predetermined recording medium. The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing apparatus 10 according to the embodiment of the present disclosure, the CPU 1100 of the computer 1000 implements the functions of the control unit 12 by executing the information processing program loaded on the RAM 1200. In addition, the storage 1400 stores an information processing program according to the present disclosure and data in the storage unit 11. Note that the CPU 1100 reads the program data 1450 from the storage 1400 and executes the program data 1450, but as another example, these programs may be acquired from another device via the external network 1550.

### 5. Conclusion

As described above, according to an embodiment of the present disclosure, the information processing apparatus 10 includes the conversion unit 11ba that converts any two notations into a linguistic unified space representation in a case where the two notations are input, the two notations being targets for determining whether or not notations are in a notation variation relationship with each other, and the notation variation determination unit 11bb (corresponding to an example of a “determination unit”) that receives a conversion result by the conversion unit 11ba as an input and determines the notation variation relationship between the two notations on the basis of a feature amount related to a notation variation included in the conversion result. Thus, it is possible to easily determine notation variation and structure notation data without considering differences in a character type or a linguistic zone of the notation.

Although the embodiments of the present disclosure have been described above, the technical scope of the present disclosure is not limited to the above-described embodiments as it is, and various modifications can be made without departing from the gist of the present disclosure. Furthermore, components of different embodiments and modification examples may be appropriately combined.

Furthermore, the effects in the embodiments described in the present description are merely examples and are not limited, and other effects may be provided.

Note that the present technology can also have the following configurations.

(1)

An information processing apparatus, comprising:
a conversion unit that converts any two notations into a linguistic unified space representation in a case where the two notations are input, the two notations being targets for determining whether or not the two notations are in a notation variation relationship with each other; and
a determination unit that receives a conversion result by the conversion unit as an input and determines the notation variation relationship between the two notations on a basis of a feature amount related to a notation variation included in the conversion result.
   (2)

The information processing apparatus according to (1), wherein
the conversion unit
extends each of the two notations to N-best and then converts the notations into the unified space representation.
   (3)

The information processing apparatus according to (1) or (2), wherein
the conversion unit
converts the two notations into the unified space representation of a character type.
   (4)

The information processing apparatus according to (1), (2) or (3), wherein
the conversion unit
converts the two notations into the unified space representation that is an embedded space representation by deep learning.
   (5)

The information processing apparatus according to any one of (1) to (4), wherein
the determination unit
determines the notation variation relationship on a basis of the feature amount including at least an editing distance of the two notations, respective lengths, and a difference between the lengths.
   (6)

The information processing apparatus according to (5), wherein
the determination unit
determines the notation variation relationship on a basis of the feature amount further including a statistic related to an editing path that is traceable in a reverse order in such a manner that the editing distance becomes zero.
   (7)

The information processing apparatus according to (6), wherein
the determination unit
determines the notation variation relationship on a basis of the feature amount including the statistic calculated on a basis of a case of the existing two notations collected in advance.
   (8)

The information processing apparatus according to any one of (1) to (7), further comprising:
an acquisition unit that acquires a notation list that is a list of any notations; and
a structuring processing unit that generates notation data in which the notation list is structured for each group with respect to notation variation by recursively repeating determination by the determination unit receiving the two notations extracted from the notation list as inputs.
   (9)

The information processing apparatus according to (8), wherein
the structuring processing unit
further generates the notation data according to a notation type including at least a character type.
   (10)

The information processing apparatus according to (8) or (9), further comprising:
a display unit; and
a display control unit that causes the display unit to display the notation data generated by the structuring processing unit.
   (11)

The information processing apparatus according to (10), wherein
the display control unit
causes, in a case where there are same notations indicating respective different entities in the notation data, the notation data to be displayed on the display unit in such a manner that the same notations are capable of being separated by the entities.
   (12)

The information processing apparatus according to (11), wherein
the display control unit
causes the display unit to display the notation data in such a manner that the same notations are capable of being separated by topics on a basis of context related to each of the entities.
   (13)

The information processing apparatus according to (12), wherein
the display control unit
extracts the topics on a basis of a medium related to each of the entities.
   (14)

The information processing apparatus according to any one of (8) to (13), wherein
the structuring processing unit
generates, in a case where one notation is designated as a search query, the notation data in such a manner that the notation data of the group to which the one notation belongs is collectively available as the search query.
   (15)

An information processing method, comprising:
converting any two notations into a linguistic unified space representation in a case where the two notations are input, the two notations being targets for determining whether or not the two notations are in a notation variation relationship with each other; and
receiving a conversion result by the converting as an input and determining the notation variation relationship between the two notations on a basis of a feature amount related to a notation variation included in the conversion result.

### REFERENCE SIGNS LIST

3 OPERATING UNIT
5 DISPLAY UNIT
10 INFORMATION PROCESSING APPARATUS
11 STORAGE UNIT
11a NOTATION LIST
11b NOTATION VARIATION DETERMINATION MODEL
11ba CONVERSION UNIT
11bb NOTATION VARIATION DETERMINATION UNIT
11c STRUCTURED NOTATION DATA
11d NOTATION DATABASE
12 CONTROL UNIT
12a ACQUISITION UNIT
12b STRUCTURING PROCESSING UNIT
12c DISPLAY CONTROL UNIT
12d EDITING PROCESSING UNIT
51 INPUT FIELD
52 OUTPUT FIELD

1. An information processing apparatus, comprising:
a conversion unit that converts any two notations into a linguistic unified space representation in a case where the two notations are input, the two notations being targets for determining whether or not the two notations are in a notation variation relationship with each other; and
a determination unit that receives a conversion result by the conversion unit as an input and determines the notation variation relationship between the two notations on a basis of a feature amount related to a notation variation included in the conversion result.

2. The information processing apparatus according to claim 1, wherein
the conversion unit
extends each of the two notations to N-best and then converts the notations into the unified space representation.

3. The information processing apparatus according to claim 1, wherein
the conversion unit
converts the two notations into the unified space representation of a character type.

4. The information processing apparatus according to claim 1, wherein
the conversion unit
converts the two notations into the unified space representation that is an embedded space representation by deep learning.

5. The information processing apparatus according to claim 1, wherein
the determination unit
determines the notation variation relationship on a basis of the feature amount including at least an editing distance of the two notations, respective lengths, and a difference between the lengths.

6. The information processing apparatus according to claim 5, wherein
the determination unit
determines the notation variation relationship on a basis of the feature amount further including a statistic related to an editing path that is traceable in a reverse order in such a manner that the editing distance becomes zero.

7. The information processing apparatus according to claim 6, wherein
the determination unit
determines the notation variation relationship on a basis of the feature amount including the statistic calculated on a basis of a case of the existing two notations collected in advance.

8. The information processing apparatus according to claim 1, further comprising:
an acquisition unit that acquires a notation list that is a list of any notations; and
a structuring processing unit that generates notation data in which the notation list is structured for each group with respect to notation variation by recursively repeating determination by the determination unit receiving the two notations extracted from the notation list as inputs.

9. The information processing apparatus according to claim 8, wherein
the structuring processing unit
further generates the notation data according to a notation type including at least a character type.

10. The information processing apparatus according to claim 8, further comprising:
a display unit; and
a display control unit that causes the display unit to display the notation data generated by the structuring processing unit.

11. The information processing apparatus according to claim 10, wherein
the display control unit
causes, in a case where there are same notations indicating respective different entities in the notation data, the notation data to be displayed on the display unit in such a manner that the same notations are capable of being separated by the entities.

12. The information processing apparatus according to claim 11, wherein
the display control unit
causes the display unit to display the notation data in such a manner that the same notations are capable of being separated by topics on a basis of context related to each of the entities.

13. The information processing apparatus according to claim 12, wherein
the display control unit
extracts the topics on a basis of a medium related to each of the entities.

14. The information processing apparatus according to claim 8, wherein
the structuring processing unit
generates, in a case where one notation is designated as a search query, the notation data in such a manner that the notation data of the group to which the one notation belongs is collectively available as the search query.

15. An information processing method, comprising:
converting any two notations into a linguistic unified space representation in a case where the two notations are input, the two notations being targets for determining whether or not the two notations are in a notation variation relationship with each other; and
receiving a conversion result by the converting as an input and determining the notation variation relationship between the two notations on a basis of a feature amount related to a notation variation included in the conversion result.
